(19) United States
(12) Patent Application Publication
(10) Pub. No.: US 2007/0103913 A1
(43) Pub. Date: May 10, 2007

(54) Lamp

(76) Inventor: Su-Ju Lin, Keelung City (TW)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 11/268,062

(22) Filed: Nov. 7, 2005

(51) Int. Cl. F21V 15/00

(52) U.S. Cl. 362/362

(57) ABSTRACT

A lamp includes: a base formed with a central hole and having two opposite mounting portions projecting into the central hole; a support seat having a pair of opposite supporting walls that respectively stand upright from the mounting portions of the base, and that cooperatively define an accommodating space which is in spatial communication with the central hole; and a lamp seat adapted to support a lamp member thereon, pivotably mounted on the mounting portions of the base, and including a pair of opposite lamp walls that are disposed between and that are slidably and respectively connected to the supporting walls of the support seat. The lamp seat is rotatable relative to the support seat so as to move in and out of the accommodating space in the support seat.

### BACKGROUND OF THE INVENTION

1. Field of the Invention

The invention relates to a lamp, more particularly to a lamp with a lamp seat pivotable relative to a lamp base.

2. Description of the Related Art

As shown in FIGS. 1 and 2, a conventional lamp 1 includes a lamp seat 11, a light unit 12 received in the lamp seat 11, and a base 13 with a mounting seat 14 defining a passage 141. The lamp seat 11 is pivotably connected to the mounting seat 14. The lamp seat 11 has an arcuate wall 112 provided with a slide engaging member 113. The lamp 1 further includes an arcuate frame plate 15 formed with a frame slot 150, and having one end mounted on the mounting seat 14. The lamp 1 further has a screw 16 that interconnects the frame plate 15 and the slide engaging member 113 by extending through the frame slot 150 in the frame plate 15 to engage threadedly the slide engaging member 113 so as to permit sliding movement of the lamp seat 11 along the frame slot 150 in the frame plate 15. A coil spring 17 is sleeved on the screw 16. The lamp seat 11 is prevented from sliding when the screw 16 is tightened, thereby positioning the lamp seat 11 at a desired position relative to the mounting seat 14.

The conventional lamp 1 is disadvantageous in that since the frame plate 15 is elongated and thin in shape and has only one end secured to the mounting seat 14, undesired bending and damage to the frame plate 15 can occur during sliding movement of the lamp seat 11 along the frame slot 150 in the frame plate 15. Moreover, sliding movement of the lamp seat 11 on the frame plate 15 is likely to be unstable.

### SUMMARY OF THE INVENTION

Therefore, the object of the present invention is to provide a lamp that can overcome the aforesaid drawbacks of the prior art.

Accordingly, a lamp of this invention comprises: a base formed with a central hole and having two opposite mounting portions projecting into the central hole; a support seat having a pair of opposite supporting walls that respectively stand upright from the mounting portions of the base, and that cooperatively define an accommodating space which is in spatial communication with the central hole; and a lamp seat adapted to support a lamp member thereon, pivotably mounted on the mounting portions of the base, and including a pair of opposite lamp walls that are disposed between and that are slidably and respectively connected to the supporting walls of the support seat. The lamp seat is rotatable relative to the support seat so as to move in and out of the accommodating space in the support seat.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional lamp;

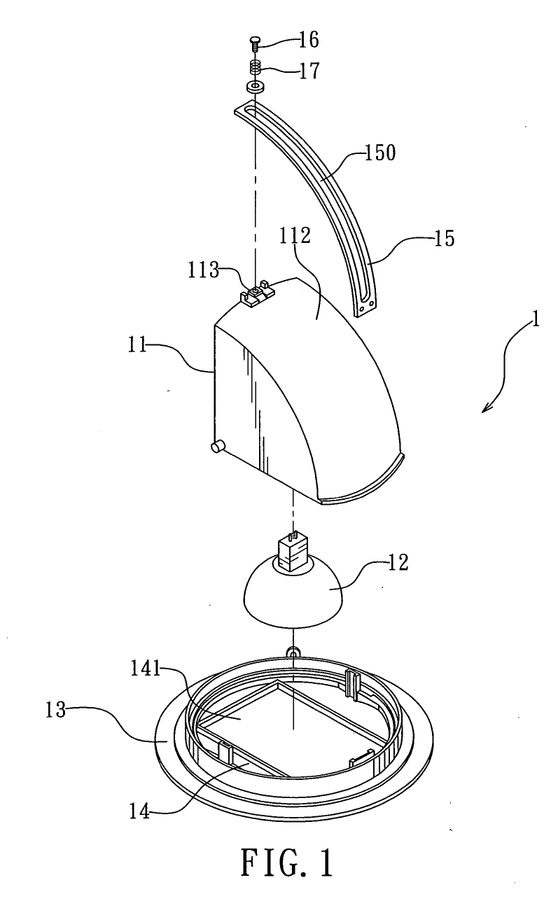

FIG. 2 is a schematic partly sectional view to illustrate pivoting movement of a lamp seat of the conventional lamp;

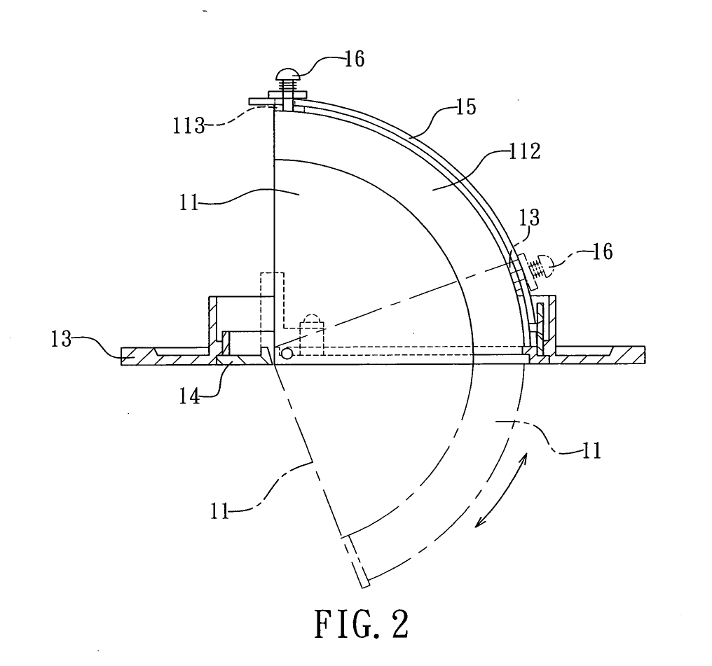

FIG. 3 is an exploded perspective view of the preferred embodiment of a lamp according to the present invention; and

FIG. 4 is a schematic partly sectional view to illustrate pivoting movement of a lamp seat of the preferred embodiment.

### DETAILED DESCRIPTION OF THE PREFERRED EMBODIMENT

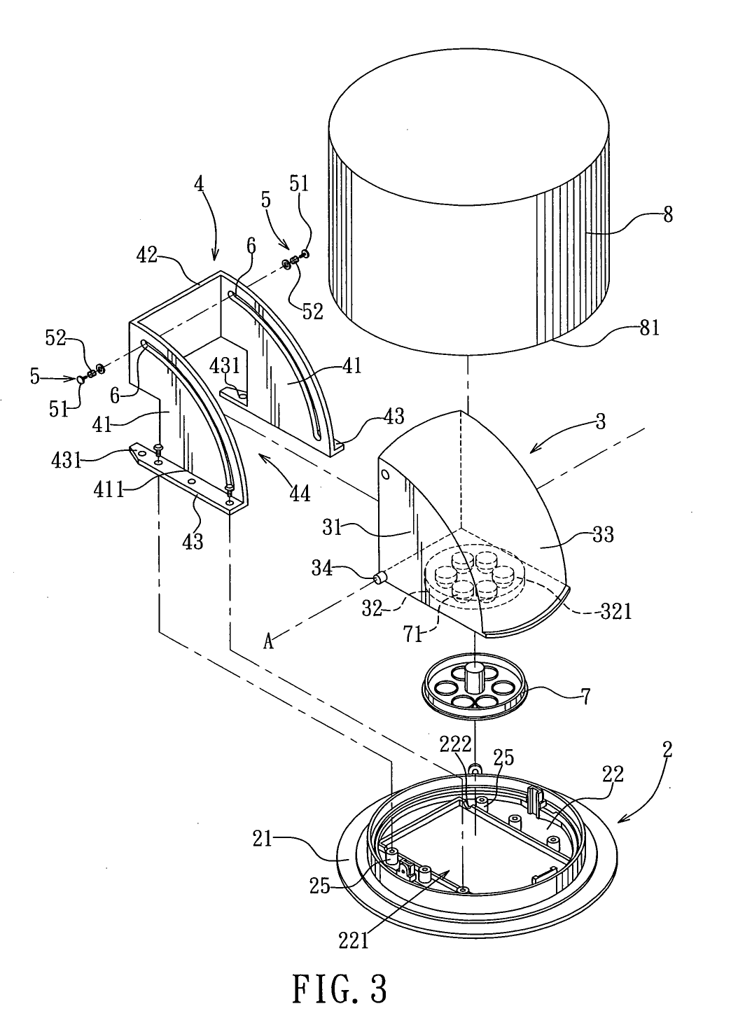

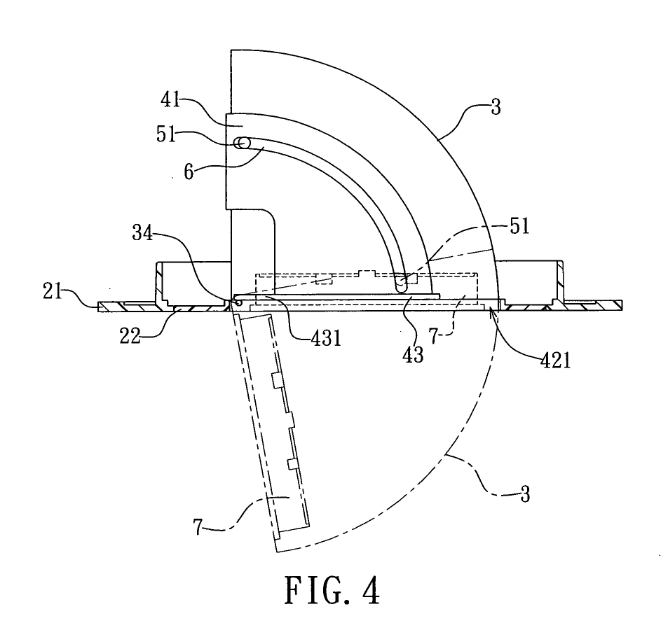

Referring to FIGS. 3 and 4, the preferred embodiment of a lamp according to the present invention is shown to include: a base 2 formed with a central hole 221 and having two opposite mounting portions 22 projecting into the central hole 221; a support seat 4 having a pair of opposite supporting walls 41 that respectively stand upright from the mounting portions 22 of the base 2, and that cooperatively define an accommodating space 44 which is in spatial communication with the central hole 221; and a lamp seat 3 adapted to support a lamp member 7 thereon, pivotably mounted on the mounting portions 22 of the base 2, and including a pair of opposite lamp walls 31 that are disposed between and that are slidably and respectively connected to the supporting walls 41 of the support seat 4. The lamp seat 3 is rotatable relative to the support seat 4 so as to move in and out of the accommodating space 44 in the support seat 4.

In this embodiment, the base 2 further has an outer ring frame 21 extending outwardly from the mounting portions 22.

The supporting walls 41 are formed with a pair of opposite arcuate slots 6, respectively. The lamp further includes a pair of coupling members 5, each of which includes a screw 51 that extends through a respective one of the arcuate slots 6 to engage threadedly a respective one of the lamp walls 31 so as to permit sliding movement of the lamp seat 3 along the arcuate slots 6 during pivoting movement of the lamp seat 3 relative to the support seat 4. Each of the coupling members 5 further includes a coil spring 52 that is sleeved on the screw 51. After assembly, each of the screws 51 serves as a slider sliding along the respective one of the arcuate slots 6. The coil springs 52 resiliently buffer the engagement between the screws 51 and the lamp walls 31 so as to prevent the screws 51 from engaging too tightly the lamp walls 31, which can hinder sliding along the arcuate slots 6.

The mounting portions 22 of the base 2 are formed with a pair of opposite pivot grooves 222, respectively. The lamp walls 31 are formed with a pair of pivot studs 34 projecting therefrom into the pivot grooves 222, respectively, and cooperating with each other to form a pivot axis (A), so as to permit pivoting movement of the lamp seat 3 relative to the support seat 4 about the pivot axis (A). Moreover, each of the supporting walls 41 has a bottom end 411 that is formed with a wing plate 43 extending laterally therefrom. Each of the mounting portions 22 of the base 2 is formed with a mounting post 25 that is disposed adjacent to a respective one of the pivot grooves 222. The lamp further includes fasteners 9 that extend through the wing plates 43 and into the mounting posts 25, respectively, so as to fasten the support seat 4 to the base 2. Moreover, the wing plate 43 of each of the supporting walls 41 has an end section 431 extending over a top side of a respective one of the pivot grooves 222 so as to confine the top side of the respective one of the pivot grooves 222 and so as to prevent undesired removal of the pivot studs 34 from the pivot grooves 222.

In this embodiment, the support seat 4 further has a connecting plate 42 that interconnects the supporting walls 41 so as to enhance the structural strength of the support seat 4 and to prevent undesired bending of the supporting walls 41 during sliding movement of the lamp seat 3.

In this embodiment, the lamp walls 31 of the lamp seat 3 have a fan-like shape. The lamp seat 3 further includes an arcuate wall 33 interconnecting the lamp walls 31. The lamp 7 member includes at least one light unit 71. The number of the light units 71 can be larger than one according to the actual requirement. Each light unit 71 can be a light-emitting diode (LED).

The lamp further includes a lamp shade 8 having a bottom edge 81 mounted on the outer ring frame 21 of the base 2 for covering the lamp seat 3.

Referring to FIG. 4, in use, when the lamp seat 3 is pivoted upwardly about the pivot axis (A) relative to the support seat 4 so as to move in the accommodating space 44 in the support seat 4 and toward the connecting plate 42, the coupling members 5 will slide to upper ends of the arcuate slots 6. On the other hand, when the lamp seat 3 is pivoted downwardly about the pivot axis (A) relative to the support seat 4 so as to move out of the accommodating space 44 in the support seat 4 and away from the connecting plate 42, the coupling members 5 will slide to lower ends of the arcuate slots 6.

With the inclusion of the support seat 4 in the lamp of this invention, the aforesaid drawbacks associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A lamp comprising:
a base formed with a central hole and having two opposite mounting portions projecting into said central hole;
a support seat having a pair of opposite supporting walls that respectively stand upright from said mounting portions of said base, and that cooperatively define an accommodating space which is in spatial communication with said central hole; and
a lamp seat adapted to support a lamp member thereon, pivotably mounted on said mounting portions of said base, and including a pair of opposite lamp walls that are disposed between and that are slidably and respectively connected to said supporting walls of said support seat, said lamp seat being rotatable relative to said support seat so as to move in and out of said accommodating space in said support seat.

2. The lamp of claim 1, wherein said supporting walls are formed with a pair of opposite arcuate slots, said lamp further comprising a pair of coupling members, each of which includes a screw that extends through a respective one of said arcuate slots to engage threadedly a respective one of said lamp walls so as to permit sliding movement of said lamp seat along said slots during pivoting movement of said lamp seat relative to said support seat.

3. The lamp of claim 2, wherein each of said coupling members further includes a coil spring that is sleeved on said screw.

4. The lamp of claim 3, wherein said mounting portions of said base are formed with a pair of opposite pivot grooves, said lamp walls being formed with a pair of pivot studs projecting therefrom into said pivot grooves, respectively, so as to permit pivoting movement of said lamp seat relative to said support seat.

5. The lamp of claim 4, wherein each of said supporting walls has a bottom end that is formed with a wing plate extending laterally therefrom, each of said mounting portions of said base being formed with a mounting post that is disposed adjacent to a respective one of said pivot grooves, said lamp further comprising fasteners that extend through said wing plates of said supporting walls and into said mounting posts of said mounting portions so as to fasten said support seat to said base, said wing plate of each of said supporting walls extending over a top side of a respective one of said pivot grooves so as to confine the top side of the respective one of said pivot grooves and so as to prevent undesired removal of said pivot studs from said pivot grooves.

6. The lamp of claim 5, wherein said support seat further has a connecting plate that interconnects said supporting walls.
